(19) United States
(12) Patent Application Publication
(10) Pub. No.: US 2008/0183781 A1
(43) Pub. Date: Jul. 31, 2008

(54) MULTI-METHOD INPUT ARRANGEMENT

(76) Inventors: Alistair Hamilton, Stony Brook, NY (US); Markus Heberlein, Brooklyn, NY (US); Victor Guerrido, Bellport, NY (US); JaeHo Choi, Whitestone, NY (US); Edwin Booth, Brooklyn, NY (US); Curt Croley, Stony Brook, NY (US)

Correspondence Address: FAY KAPLUN & MARCIN, LLP, 150 BROADWAY, SUITE 702, NEW YORK, NY, 10038, US

(21) Appl. No.: 11/668,283

(22) Filed: Jan. 29, 2007

(51) Int. Cl. G06F 15/04

(52) U.S. Cl. 708/130

(57) ABSTRACT

An input arrangement for a mobile device may include (a) a manual input mechanism producing a primary input when engaged; and (b) first and second state shifting mechanisms respectively producing first and second secondary inputs when used in combination with an initial engaging of the manual input mechanism. Each of the first and second state shifting mechanisms also produces a further secondary input when used in combination with a subsequent engaging of the manual input mechanism. The further secondary input produced by the combination of the manual input mechanism and the second state shifting mechanism is the first secondary input.

### FIELD OF THE INVENTION

The present invention generally relates to input arrangements for mobile devices.

### BACKGROUND INFORMATION

Mobile devices, such as cell phones, PDAs, barcode scanners, RF-ID readers, etc. are capable of many functionalities. In order to access these functions, a mobile device may require an input arrangement, such as a second keypad, a touch-screen, a pin-pad, etc. However, size and/or mobility constraints limit how large the input arrangement can be. In response to this problem, conventional methods such as shift keys and multi-tapping were introduced. However, as described below, these conventional methods are inefficient.

FIG. 1 shows a conventional input arrangement (e.g., a keypad 100) that utilizes multi-tapping. The keypad 100 includes one or more keys for entering input. For example, a key 110 may be used to input the character “1” and a key 120 may be used to confirm the input and enter it into a memory or transmit the input to a processing unit. In this manner, a user may enter any character from 0-9. However, because size constraints limit a total number of keys available, one or more keys (e.g., the key 110) are used to input additional characters. As shown in FIG. 1, a label 112 is printed above the key 110, indicating that the key 110 may be used to produce any of the letters A-C. This is accomplished by engaging (e.g., pressing) the key 110 multiple times. For example, if a user wishes to input a lowercase letter “a”, the key 110 is pressed twice. If a lowercase letter “b” is desired, the key 110 is pressed three times. Thus, an initial press results in an input of a primary character (e.g., “1”) and subsequent presses result in an input of secondary characters, with each subsequent press inputting a corresponding character as denoted by the label 112.

FIG. 2 shows a conventional keypad 200 that utilizes a shift key. The keypad 200 has a plurality of keys, including an input key 210, a shift key 230, and a confirmation key 220. Similar to the keypad 100, an initial press of the key 220 produces a primary character (e.g., “1”). However, subsequent presses also produce the same primary character unless an initial state of the device 200 is shifted by pressing the shift key 230. The shift key 230 enables a second state in which an alternate character is produced. For example, if the exclamation character “!” is desired, the second state is entered by simultaneously pressing the shift key 230 and the key 210.

Although the keypads 100 and 200 are capable of allowing the user to input a large number of characters using a limited number of keys, the multi-tapping and shift key methods utilized by the keypads 100, 200 are time consuming. In addition, the user is forced to learn one particular method (e.g., multi-tapping, shift key) of input. If the user has multiple devices, each requiring a different input method, this can lead to confusion and/or unnecessary learning of multiple input methods.

### SUMMARY OF THE INVENTION

The present invention relates to an input arrangement for a mobile device. The input arrangement may include (a) a manual input mechanism producing a primary input when engaged; and (b) first and second state shifting mechanisms respectively producing first and second secondary inputs when used in combination with an initial engaging of the manual input mechanism. Each of the first and second state shifting mechanisms also produces a further secondary input when used in combination with a subsequent engaging of the manual input mechanism. The further secondary input produced by the combination of the manual input mechanism and the second state shifting mechanism is the first secondary input.

### BRIEF DESCRIPTION OF THE DRAWINGS

FIG. 1 shows a conventional input arrangement;

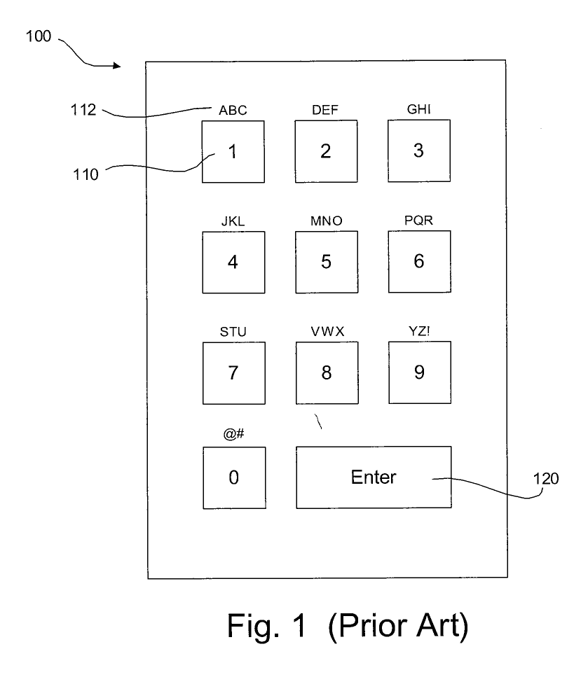

FIG. 2 shows another conventional input arrangement;

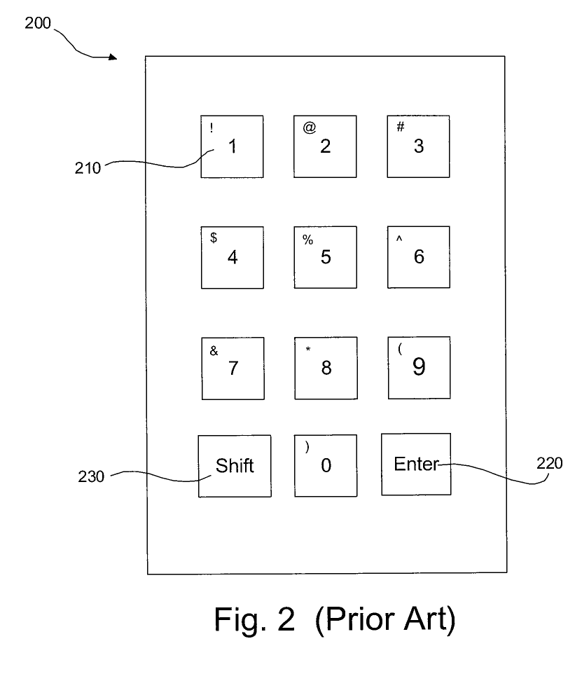

FIG. 3 is an exemplary embodiment of an mobile device according to the present invention;

FIG. 4 is an exemplary embodiment of a function table according to the present invention; and

FIG. 5 is an exemplary embodiment of an input arrangement according to the present invention.

### DETAILED DESCRIPTION

The present invention may be further understood with reference to the following description and the appended drawings, wherein like elements are provided with the same reference numerals. The present invention relates to input arrangements for mobile devices (e.g., mobile units (“MUs”)). The present invention may be implemented with any type of MU (e.g., a cell phone, a PDA, a barcode scanner, an RF-ID reader, a hand-held computer, etc.) that utilizes an input arrangement (e.g., a keypad, a touch-screen, a pin-pad etc.).

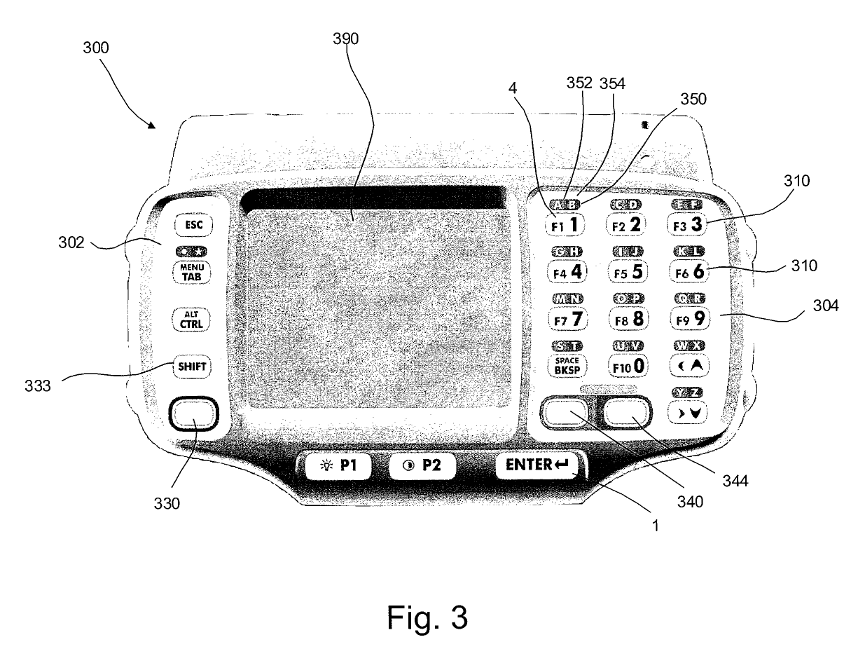

FIG. 3 shows an exemplary embodiment of an MU 300 according to the present invention. The MU 300 may include a display (e.g., an LCD screen 390) and one or more input arrangements (e.g., a first keypad 302 and a second keypad 304). In addition, other input arrangements (e.g., keys, switches, etc.) may be disposed throughout a housing of the MU 300. For example, the MU 300 may include a confirmation key (e.g., an “Enter” key 1) on a proximal portion of the housing. The first keypad 302 may include a function key 330 and a shift key 333. The second keypad 304 may include a plurality of labeled input keys 310 and one or more color-shift keys 340 and 344. As will be described below, the shift key 333 and the color-shift keys 340 and 344 are each used for shifting the MU 300 into a new state in which the input keys 310 can produce additional output. However, the functionality of these keys is different. For instance, an output produced using the shift key 333 may differ from that produced using the color-shift keys 340, 344. These outputs produced using the shift keys 333, 340 and 344 will be described in further detail below.

In an exemplary embodiment, the second keypad 304 includes two shift keys (i.e., the color-shift keys 340, 344). As explained below, the number of color-shift keys on the second keypad 304 may correspond to a total number of characters depicted in each of a plurality of labels (e.g., a label 350) associated with each key 310. Thus, in other embodiments, there may be any plurality of color-shift keys.

Each key 310 may have a primary character associated therewith, such that when the key 310 is engaged (e.g., tapped, pressed-down, etc.), the primary character is inputted into a processing unit (e.g., a CPU, a logic circuit, an embedded controller, etc.) of the MU 300. The input may be visually confirmed by displaying the primary character on the LCD 390. For example, if the key 4 is pressed, the character “1” is inputted and may be shown on the LCD 390. If a user is satisfied with this input, it may be manually confirmed by pressing the Enter key 1. Otherwise, the input may be erased by, for example, pressing another key (e.g., a delete or clear button) to delete and/or overwrite the input.

In addition to the primary character, the functionality of each key 310 may be extended by enabling the input of one or more alternate characters. For example, an alternate character for the key 4 may be an exclamation mark (not shown). To produce the alternate character, the user may press the shift key 333 in combination with (e.g., simultaneously with, prior to, or after) the key 4. The pressing of the shift key 333 shifts the MU 300 from an initial state in which the keys 310 are only capable of producing the primary characters, to a second state in which the keys 310 are able to produce the alternate characters. Those of skill in the art will understand that there are multiple ways in which state shifting may be performed and that this may depend on a particular implementation of a control logic of the MU 300. For example, the control logic may be implemented as a finite state machine using digital logic.

Each key 310 may also produce a function (e.g., “F1”, “F2”, “F3”, etc.) activated by pressing the function key 330 in combination with the key 310. Each function may be printed or inscribed next to the primary character on each key 310. For example, the characters “F1” and “1” may be printed on the key 4 to denote that the key 4 may be used to produce the function “F1” or the character “1”. Thus, if the function “F1” is desired, the user may press the function key 330 simultaneously with, or prior to, pressing the key 4. Used in this manner, the function key 330 may operate in a manner similar to that of the shift key.

In addition to the primary characters, the alternate characters and the functions, each key 310 may also be used to input one or more secondary characters, which may be indicated using a label printed above each key 310. For instance, the label 350 may be printed above the key 4, indicating the secondary characters “A” and “B”. In an exemplary embodiment, there are multiple methods of inputting the secondary characters. For example, a first method may be state shifting, in which each secondary character may correspond to one of the color-shift keys 340, 344. Because each label has two secondary characters and there are two color-shift keys 340 and 344 on the second keypad 304, there is a one-to-one correspondence between the secondary characters and the color-shift keys 340, 344. Pressing of the color-shift keys 340, 344 may shift the MU 300 from the initial state to a state that produces lowercase forms of the secondary characters. Thus, to input the lowercase character “a”, the user may press the color-shift key 340 simultaneously with, prior to, or subsequent to pressing the key 4. Similarly, to input the lowercase character “b”, the user may press the color-shift key 344 simultaneously with, prior to, or subsequent to pressing the key 4.

To produce uppercase characters, the color-shift keys 340, 344 may be used in combination with the shift key 333. For example, to input an uppercase character “A”, the user may press the color-shift keys 333 and 340 simultaneously, followed by the key 4. Thus, when used together, a combination of the shift key 333 with one of the color-shift keys 340, 344 may shift the MU 300 into a further state.

In order to make an association between the color-shift keys 340, 344 and the secondary characters obvious to the user, the color-shift keys 340, 344 and the labels may be marked (e.g., colored, highlighted, underlined, font manipulated, etc.). For example, the color-shift key 340 may be colored orange and the color-shift key 344 colored gray. Accordingly, a portion (e.g., a first portion 352) of the label 350 denoting a first secondary character (e.g., a secondary character “A”) may be colored orange to match the color-shift key 340 and a second portion 354 of the label 350 denoting a second secondary character (e.g., a secondary character “B”) may be colored gray to match the color-shift key 344.

In addition to the first method described above, the MU 300 may utilize another input method that is a hybrid approach combining state shifting and multi-tapping. Using this method, it may be possible to utilize either of the color-shift keys 340, 344 in combination with the keys 310 to produce both the first and the second secondary characters. For example, if the user presses the color-shift key 340 followed by two presses of the key 4, this may produce the lowercase character “b”. Similarly, if the user presses the color-shift key 344 followed by two presses of the key 4, this may produce the lowercase character “a”. Thus, secondary characters normally associated with a particular shift key can be produced using another shift key.

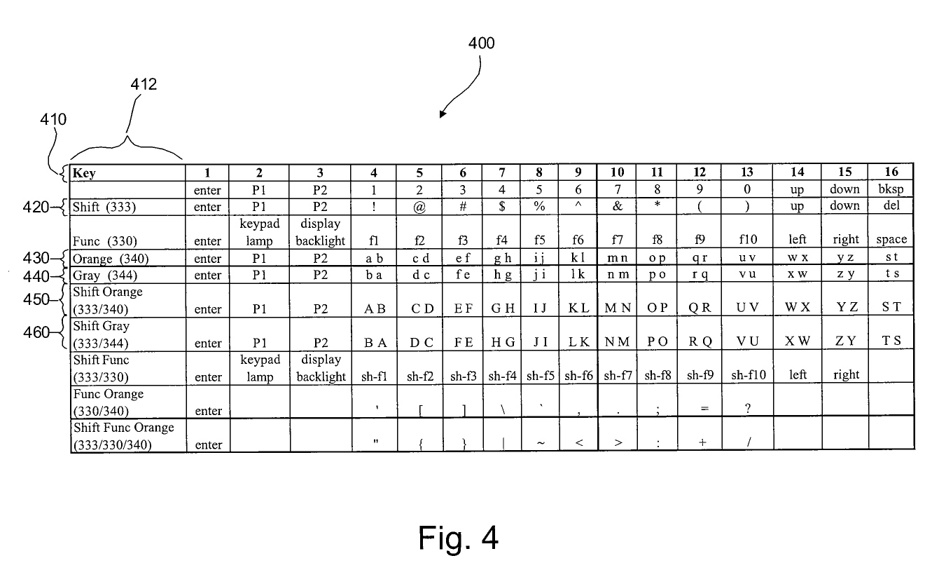

FIG. 4 shows an exemplary embodiment of a function table 400 according to the present invention. The table 400 is a list of characters and functions that may be produced using the keys 310. It will be understood that the table 400 may not necessarily be an exhaustive list, but is only an exemplary embodiment showing how various input methods may be utilized in combination with the MU 300. For example, in the exemplary embodiment shown in FIG. 4, the table 400 shows how different methods may be used to input the primary and secondary characters.

A first row 410 of the table 400 lists a first set of keys on the MU 300. These keys may include the keys 310, the Enter key 1 and any other input key used by the MU 300. A first column 412 of the table 400 includes a second set of keys that are used in combination with the first key set for producing the input. The second key set may, for example, include the function key 330 and the color-shift keys 340, 344. As shown in FIG. 4, pressing the key 4 without combining any other keys (i.e., pressing the key 4 once) produces the character “1”. Pressing the key 4 in combination with the function (e.g., “Func”) key 330 produces the function “F1”.

A conventional shift key method is illustrated by a second row 420, which shows input that may be produced using a combination of a shift key (e.g., the shift key 333) and another input key (e.g., the keys 310). A third row 430, a fourth row 440 and a fifth row 450 show alternate methods of entering input. As shown in the rows 430 and 440, lowercase forms of the secondary characters may be produced using orange- and gray-colored shift keys (e.g., the color-shift keys 340, 344) when a key from the first key set (e.g., the key 4) is pressed once and twice, respectively. As further illustrated in the rows 440 and 450, uppercase forms of the secondary characters may be produced when the color-shift keys 340, 344 are used in combination with the shift 333 key and the keys from the first key set. Other key combinations may also be possible. For example, as shown in FIG. 4, any combination of the shift key 333, the function key 330 and the color-shift keys 340, 344 may be used to produce a particular input.

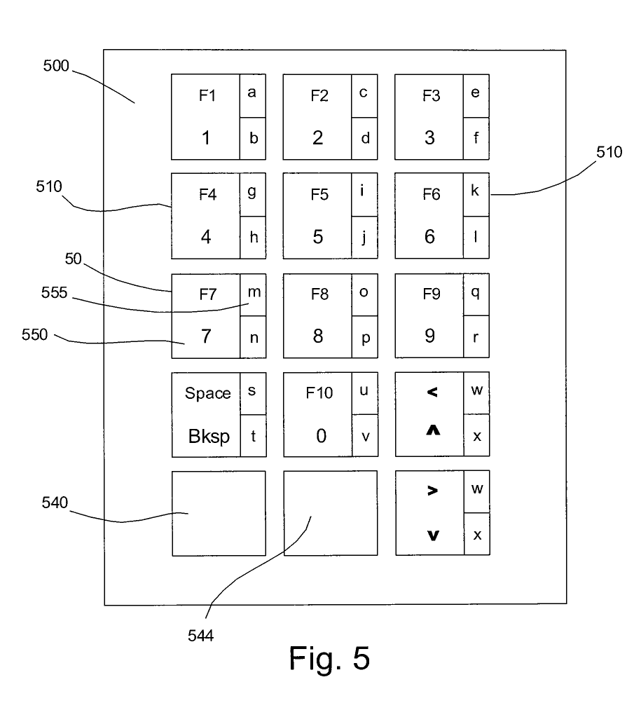

FIG. 5 shows an alternative embodiment of an input arrangement (e.g., a keypad 500) according to the present invention. As shown in FIG. 5, the keypad 500 may include one or more color-shift keys 540 and 544 and one or more input keys 510. The color-shift keys 540, 544 may perform functions substantially similar to those of the color-shift keys 340, 344. For example, the color-shift key 540 may be used in combination with a key 50 to produce a secondary input (e.g., “m”) and the color-shift key 544 may be used in combination with the key 50 to produce another secondary input (e.g., “n”). The secondary inputs were previously described as printed on a label above each key. However, in the exemplary embodiment of the keypad 500, the secondary inputs may be printed directly on each key 510. The secondary inputs may be printed in a smaller font to indicate their status as secondary. As shown in FIG. 5, the key 50 may be divided into a primary portion 550 on which the primary inputs “F7” and “7” are printed and a secondary portion 555 on which the secondary inputs “m” and “n” are printed. The secondary portion 555 may be set at an angle to the primary portion 550 to further distinguish the portions 550, 555 from one another.

The MU 300 provides for an enhanced level of user-friendliness compared to MUs that utilize conventional input methods. In retaining the conventional input methods, the MU 300 allows the user to continue using a conventional method (e.g., shift key, multi-tapping) that the user is already familiar with. In addition, the methods described above provide for faster inputting. For example, as previously discussed, if the user wishes to input the character “b” using multi-tapping, an input key may have to be pressed three times. Using the first method however, the user would only have to press the color-shift key 344 and the key 4, for a total of two presses. Thus, input efficiency is increased.

Another advantage of the MU 300 is that it allows the user to choose from a number of possible input methods. For example, the user may find that the hybrid method, which uses shifted states and multi-tapping, is more intuitive than using a purely multi-tapping input method. In addition, it may be possible for the user to selectively disable and re-enable a particular input method. The present invention is therefore highly adaptable to the input preferences of multiple users.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. An input arrangement for a mobile device, comprising:
a manual input mechanism producing a primary input when engaged; and
first and second state shifting mechanisms respectively producing first and second secondary inputs when used in combination with an initial engaging of the manual input mechanism;
wherein each of the first and second state shifting mechanisms also produces a further secondary input when used in combination with a subsequent engaging of the manual input mechanism, the further secondary input produced by the combination of the manual input mechanism and the second state shifting mechanism being the first secondary input.

2. An input arrangement according to claim 1, wherein the further secondary input produced by the combination of the manual input mechanism and the first state shifting mechanism is the second secondary input.

3. An input arrangement according to claim 1, wherein the secondary inputs are depicted proximal to the manual input mechanism.

4. An input arrangement according to claim 3, wherein the depictions of each of the secondary inputs is marked so as to match a corresponding state shifting mechanism, the marking being one of coloring, highlighting, underlining and font manipulation.

5. An input arrangement according to claim 4, wherein the markings of the secondary inputs are distinguishable from each other.

6. An input arrangement according to claim 1, wherein the input arrangement includes a third state shifting mechanism producing an alternate input when used in combination with the manual input mechanism.

7. An input arrangement according to claim 6, wherein the third state shifting mechanism produces an alternate form of the secondary inputs when used in combination with the manual input mechanism and one of the first and the second state shifting mechanisms.

8. An input arrangement according to claim 1, wherein each combination includes one of engaging the manual input mechanism prior to, simultaneously with, and after engaging the state shifting mechanism.

9. An input arrangement according to claim 1, wherein each input is confirmed by engaging a manual confirmation mechanism.

10. A keypad including a plurality of keys, each key producing a primary input when engaged;
a first state shifting key that modifies the operation of the device such that each key produces a first secondary input when engaged; and
a second state shifting key that modifies the operation of the device such that each key produces a second secondary input when engaged;
wherein the second state shifting key also modifies the operation of the device such that each key produces the first secondary input when the key is engaged more than once.

11. A keypad according to claim 10, wherein the first state shifting key also modifies the operation of the device such that each key produces the second secondary input when the key is engaged more than once.

12. A keypad according to claim 10, wherein the secondary inputs are depicted proximal to each key associated therewith.

13. A keypad according to claim 12, wherein the depictions of each of the secondary inputs is marked so as to match a corresponding state shifting key, the marking being one of coloring, highlighting, underlining and font manipulation.

14. A keypad according to claim 12, wherein the markings of the secondary inputs are distinguishable from each other.

15. A keypad according to claim 10, wherein the keypad includes a third state shifting key producing an alternate input when used in combination with each key.

16. A keypad according to claim 15, wherein the third state shifting key produces an alternate form of the secondary inputs when used in combination with the key and one of the first and the second state shifting keys.

17. A keypad according to claim 10, wherein each combination includes one of engaging the key prior to, simultaneously with, and after engaging the state shifting key.

18. A keypad according to claim 10, wherein each input is confirmed by engaging a manual confirmation key.

19. A keypad according to claim 10, wherein the ability of the second state shifting key to produce the first secondary input can be disabled and re-enabled by a user.

20. An input device including a plurality of input means, each input means producing a primary input when engaged;
a first state shifting means that modifies the operation of the device such that each input means produces a first secondary input when engaged; and
a second state shifting means that modifies the operation of the device such that each input means produces a second secondary input when engaged;
wherein the second state shifting means also modifies the operation of the device such that each input means produces the first secondary input when the input means is engaged more than once.
